(19) United States
(12) Patent Application Publication
(10) Pub. No.: US 2002/0150511 A1
(43) Pub. Date: Oct. 17, 2002

(54) Piezoelectric pipetting device housing and methods for making and using the same

(76) Inventor: Peter Wiktor, Mercer Island, WA (US)

Correspondence Address: Robert M. Storwick, PO Box 386, Mercer Island, WA, 98040, US

(21) Appl. No.: 10/087,696

(22) Filed: Mar. 1, 2002

Related U.S. Application Data
(60) Provisional application No. 60/272,558, filed on Mar. 1, 2001.
(60) Provisional application No. 60/272,628, filed on Mar. 1, 2001.
(60) Provisional application No. 60/280,168, filed on Mar. 30, 2001.

(51) Int. Cl. B01L 3/00

(52) U.S. Cl. 422/100; 422/99

(57) ABSTRACT

A piezoelectric pipetting device housing and methods for making and using the same is disclosed. A protected capillary includes a rigid tube and a glass capillary that is bonded to an interior surface of the rigid tube. The protected capillary optionally includes a piezoelectric actuating element adjacent a portion of the exterior surface of the glass capillary. The protected capillary further optionally includes a sensor that is adjacent a third portion of the exterior surface of the glass capillary or a temperature regulator. Methods for making and using the protected capillary are also disclosed.

### REFERENCE TO PROVISIONAL APPLICATIONS

This application claims the benefit of the U.S. Provisional Application No. 60/272,558, filed Mar. 1, 2001. This application also claims the benefit of U.S. Provisional Application No. 60/272,628, filed Mar. 1, 2001. This application further claims the benefit of U.S. Provisional Application No. 60/280,168, filed Mar. 30, 2001.

### TECHNICAL FIELD

The present invention relates to methods and apparatus for handling fluids, and more particularly, to methods and apparatus for protecting pipetting devices.

### BACKGROUND OF THE INVENTION

Due to their many useful properties, glass capillary tubes have a broad range of applications in many different fields. Simply submerging one end of a glass capillary tube into a fluid causes the fluid to be drawn up into the tube by capillary action. Glass capillary tubes are transparent, so the level of fluid inside can easily be detected either visually or by an optical detection system.

Glass is easy to form, making it possible to manufacture glass capillary tubes to very tight tolerances. Commercial glass capillary tubes are routinely manufactured with inside and outside diameter tolerances of +/−10 micrometers. It is easy to accurately cut the lengths of glass capillary tubes by scoring a short nick on the outside surface and bending or pulling the capillary tubing apart. The tight dimensional tolerances mean that glass capillary tubes can be manufactured with very accurate internal volumes. This feature makes them useful for sampling accurate volumes of fluid. For example, capillaries are routinely used to take small samples of patients' blood for diagnostic purposes.

The tip of a glass capillary tube can be polished to an optically smooth finish by heating—a process known as fire polishing. Heating the tip further causes it to neck down, forming a constriction or nozzle. The tip of the capillary can be sealed off completely by heating it still further. A constriction in the middle of a glass capillary tube can be formed by simultaneously heating and pulling apart the ends of the tube. The tube can then be cut in half at the constriction, yielding two capillaries with nozzles formed on each end. Using this technique it is possible to manufacture nozzle openings that are only 1 micrometer in diameter.

These types of capillaries are used for electrospray applications and to take small fluid samples directly from inside individual cells. Capillary tubes can be made out of fused silica instead of glass. These types of capillaries are typically coated with some type of polymer such as polyimide or polyester, resulting in a tube that is so flexible that it can be tied in a loose knot. Polyimide coated fused silica capillary tubes are available, for example, from Polymicro Technologies, Inc., Phoenix, Ariz., www.polymicro.com. These tubes are used to transport fluid in capillary electrophoresis and capillary chromatography applications (Landers, 1997).

In 1950, Hansell (U.S. Pat. No. 2,512,743) disclosed an apparatus for the spraying of a liquid in a fine jet, or train of globules, comprising a liquid container having an intake orifice and a spray nozzle, piezo-electric means for applying compressional waves to a surface of said liquid within said container, and means for focusing the effects of said compressional waves on that part of the liquid which faces said orifice. Today, Hansell's invention is used extensively for piezoelectric, drop-on-demand, ink-jet printing applications.

In 1974, Zoltan (U.S. Pat. No. 3,840,758) disclosed a drop-on-demand, piezoelectric, ink-jet dispenser with a cylindrical geometry. One of the constructions disclosed by Zoltan has a small bore diameter liquid supply tube extending through a piezoelectric ceramic tube. One end of the liquid supply tube is necked down forming an orifice.

Ink-jet printing is the original and still most prevalent application for drop-on-demand, piezoelectric dispensers. However, these dispensers may be used for a wide variety of applications, wherever small drops of fluid (on the order of 100 picoliters) need to be dispensed. They may also be used for fluid transfer applications as disclosed in Wiktor (U.S. Pat. No. 6,232,129). In this patent, the piezoelectric device is used as a micro-pipette to acquire and then subsequently dispense fluid with a resolution of approximately 100 picoliters.

Currently there is a general trend towards miniaturization in a broad range of fields including electronics, mechanisms, micro electromechanical systems (MEMS) and biochemistry. There are applications in each one of these fields that require the ability to deliver very small, precise volumes of fluid. Drop-on-demand, piezoelectric dispensers can satisfy many of these requirements.

The piezoelectric, drop-on-demand, ink-jet dispenser as disclosed in Zoltan (U.S. Pat. No. 3,840,758) has several practical limitations that prevent it from being used reliably in a commercial setting. One limitation is that the device as disclosed in the Zoltan patent is very fragile. Typically, the liquid supply tube is made out of a thin walled glass or fused silica capillary tube. Generally, the tube protrudes out past each end of the enclosing piezoelectric ceramic tube. This glass or fused silica capillary tube is very fragile and therefore can easily break if it is mishandled or dropped accidentally. Also, the piezoelectric ceramic tube is brittle and can fracture quite easily.

Another limitation of the device disclosed in the Zoltan patent is that it does not, by itself, give any indication of its operational state (i.e., whether it is empty, clogged, broken or functioning properly). The orifice of the device is very small, on the order of 50 micrometers across the inside diameter. Consequently, the orifice can easily get clogged by small particles in the fluid, especially if the fluid is not carefully filtered before it is loaded into the device. The device can also stop working if there are small air bubbles entrapped in the fluid or if for some reason the fluid inside of the device is pulled back away from the nozzle. Without actually observing or detecting the dispensed drops by some external means, there is no indication if the device stops functioning properly.

A further limitation of the device disclosed in the Zoltan patent is that the device can only dispense fluid with relatively low viscosity. Furthermore, the device does not provide a means for raising the temperature of the dispensed fluid to lower its viscosity. In addition, the device does not have a means of regulating the temperature of the dispensed fluid to maintain uniform fluid properties for uniform drop dispensing characteristics.

### SUMMARY OF THE INVENTION

One objective of the present invention is to provide a protective housing for a glass capillary tube. This is achieved by bonding the glass capillary tube to the inside of a rigid tube.

The present invention provides improvements to the piezoelectric, drop-on-demand, ink-jet dispenser disclosed in Zoltan (U.S. Pat. No. 3,840,758). Specifically, the present invention provides a compact, rugged package for a piezoelectric pipetting device incorporating a sensor and temperature controlled tip. The present invention is a specific construction that enables the functionality disclosed in Wiktor (U.S. Pat. No. 6,232,129).

Another objective of the present invention is to overcome the limitations of a piezoelectric, drop-on-demand, ink-jet device. Compared to existing piezoelectric, drop-on-demand, ink-jet devices, the present invention provides a compact, rugged protective housing that enables easier handling, and can provide a sensing capability and/or a temperature regulation capability.

One specific objective of the present invention is to provide a protective housing for the relatively fragile glass or fused silica capillary tube of the device.

Another specific objective is to provide a protective housing for the relatively fragile piezoelectric tube of the device.

A further specific objective is to provide a means for sensing the operational state of the device, for example, whether the device is clogged, has an air bubble in the fluid, or is broken or functioning properly.

An additional specific objective is to provide a means for raising the temperature of the tip of the device relative to the ambient temperature in order to reduce the viscosity of the fluid to be dispensed inside of the device.

Still another specific objective is to provide a means of regulating a constant temperature of the dispensed fluid to maintain uniform drop dispensing characteristics.

According to one aspect, the invention is a protected capillary. The capillary includes a glass capillary that has a proximal end and a distal end, an interior surface and an exterior surface. The capillary also includes a rigid tube that has a proximal end and a distal end, an interior surface and an exterior surface. The exterior surface of the glass capillary is bonded to the interior surface of the rigid tube.

According to another aspect, the invention is a piezoelectric pipetting device including a glass capillary having a proximal end and a distal end, an interior surface and an exterior surface. The distal end is formed into a nozzle. The device also includes a rigid tube having two ends, an interior surface and an exterior surface. A first portion of the exterior surface of the glass capillary is bonded to the interior surface of the rigid tube. Further, the device includes a piezoelectric actuating element adjacent a second portion of the exterior surface of the glass capillary.

According to a further aspect, the invention is a piezoelectric pipetting device including a glass capillary that has a proximal end and a distal end, an interior surface and an exterior surface. The distal end is formed into a nozzle. The device also includes a rigid tube that has two ends, an interior surface and an exterior surface. A first portion of the exterior surface of the glass capillary is bonded to the interior surface of the rigid tube. The device further includes a piezoelectric actuating element adjacent a second portion of the exterior surface of the glass capillary, and a sensor adjacent a third portion of the exterior surface of the glass capillary.

According to yet another aspect, the invention is a piezoelectric pipetting device including a glass capillary having a proximal end and a distal end, an interior surface and an exterior surface. The distal end is formed into a nozzle. The device also includes a rigid tube that has two ends, an interior surface and an exterior surface. A first portion of the exterior surface of the glass capillary is bonded to the interior surface of the rigid tube. The device further includes a piezoelectric actuating element adjacent a second portion of the exterior surface of the glass capillary, a sensor adjacent a third portion of the exterior surface of the glass capillary, and a temperature regulator adjacent the exterior surface of an end of the glass capillary.

According to a still further aspect, the invention is a method for making a protected capillary. The method includes the steps of a) forming a glass capillary having a proximal end and a distal end, an interior surface and an exterior surface, b) forming a rigid tube having a proximal end and a distal end, an interior surface and an exterior surface, and c) bonding the exterior surface of the glass capillary to the interior surface of the rigid tube.

According to another aspect, the invention is a method for making a protected capillary. The method includes the steps of a) forming a glass capillary having a proximal end and a distal end, an interior surface and an exterior surface, b) forming the distal end of the glass capillary into a nozzle, c) forming a rigid tube having two ends, an interior surface and an exterior surface, and d) bonding a first portion of the exterior surface of the glass capillary to the interior surface of the rigid tube. The method also includes the steps of e) forming a piezoelectric actuating element, and f) affixing the piezoelectric actuating element adjacent a second portion of the exterior surface of the glass capillary.

According to another aspect, the invention is a method for making a piezoelectric pipetting device. The method includes the steps of a) forming a glass capillary having a proximal end and a distal end, an interior surface and an exterior surface, and b) forming the distal end into a nozzle. The method also includes the steps of c) forming a rigid tube having two ends, an interior surface and an exterior surface and d) bonding a first portion of the exterior surface of the glass capillary to the interior surface of the rigid tube. The method further includes the steps of e) forming a piezoelectric actuating element, f) affixing the piezoelectric actuating element adjacent a second portion of the exterior surface of the glass capillary, g) forming a sensor, and h) affixing the sensor adjacent a third portion of the exterior surface of the glass capillary.

According to a further aspect, the invention is a method for making a piezoelectric pipetting device. The method includes the steps of a) forming a glass capillary having a proximal end and a distal end, an interior surface and an exterior surface, b) forming the distal end of the glass capillary into a nozzle, c) forming a rigid tube having two ends, an interior surface and an exterior surface, and d) bonding a first portion of the exterior surface of the glass capillary to the interior surface of the rigid tube. The method further includes the steps of e) forming a piezoelectric actuating element, and f) affixing the piezoelectric actuating element adjacent a second portion of the exterior surface of the glass capillary. Also, the method includes the steps of g) forming a temperature regulator, and h) affixing the temperature regulator adjacent the exterior surface of an end of the glass capillary.

According to yet another aspect, the invention is a method for using a piezoelectric pipetting device. The method includes the steps of a) actuating a piezoelectric actuating element, adjacent a first portion of an exterior surface of a glass capillary that has a proximal end and a distal end, to draw a fluid into the glass capillary, a second distinct portion of the exterior surface of the glass capillary being bonded to an interior surface of a rigid tube, b) accessing a sensor adjacent a third portion of the exterior surface of the glass capillary to determine an operational state of the fluid, and c) determining an action based on the operational state of the fluid.

### BRIEF DESCRIPTION OF THE DRAWINGS

FIG. 1 is a cross-sectional view of a cylindrical piezoelectric pipetting device incorporating a protective housing.

FIG. 2 is a cross-sectional view of an alternate construction of a piezoelectric pipetting device incorporating a protective housing that does not conduct electricity.

FIG. 3 is cross-sectional view of a piezoelectric pipetting device incorporating a protective housing and a sensor.

FIG. 4 is a cross-sectional view of a piezoelectric pipetting device incorporating a protective housing and a means of regulating the temperature of the tip of the device.

FIG. 5 is a cross-sectional view of a piezoelectric pipetting device incorporating a protective housing, a sensor and a means of regulating the temperature of the tip of the device.

FIG. 6 is a top view of the device in FIG. 1.

FIG. 7 is a cross-sectional view of the sensor in FIG. 3 and FIG. 5.

FIG. 8 is a cross-sectional view of the thermal tip in FIG. 4 and FIG. 5.

FIG. 9 is a cross-sectional view of an alternate construction of a piezoelectric pipetting device incorporating a protective housing made out of an electrically conducting material with a electrically non-conductive coating applied to the surface of the housing.

FIG. 10 is a cross-sectional view of an alternate construction of a piezoelectric pipetting device incorporating a protective housing made out of an electrically conducting material with a electrically non-conductive coating applied to the surface of the housing and with circumferential electrical contacts.

FIG. 11 is a cross-sectional view of a glass capillary tube that is bonded inside of a rigid tube.

FIG. 12 is a cross-sectional view of a glass capillary tube with a nozzle formed on one end that is bonded inside of a rigid tube.

FIG. 13 is a top view of a rigid tube with two apertures cut into its wall allowing the enclosed capillary to be observed.

FIG. 14 is a cross-sectional view of the same arrangement as in FIG. 11 except that the glass capillary sticks out past the rigid tube at one end.

FIG. 15 is a cross-sectional view of the arrangement in FIG. 11 bonded to a female Luer fitting.

### DETAILED DESCRIPTION OF THE PREFERRED EMBODIMENT OF THE INVENTION

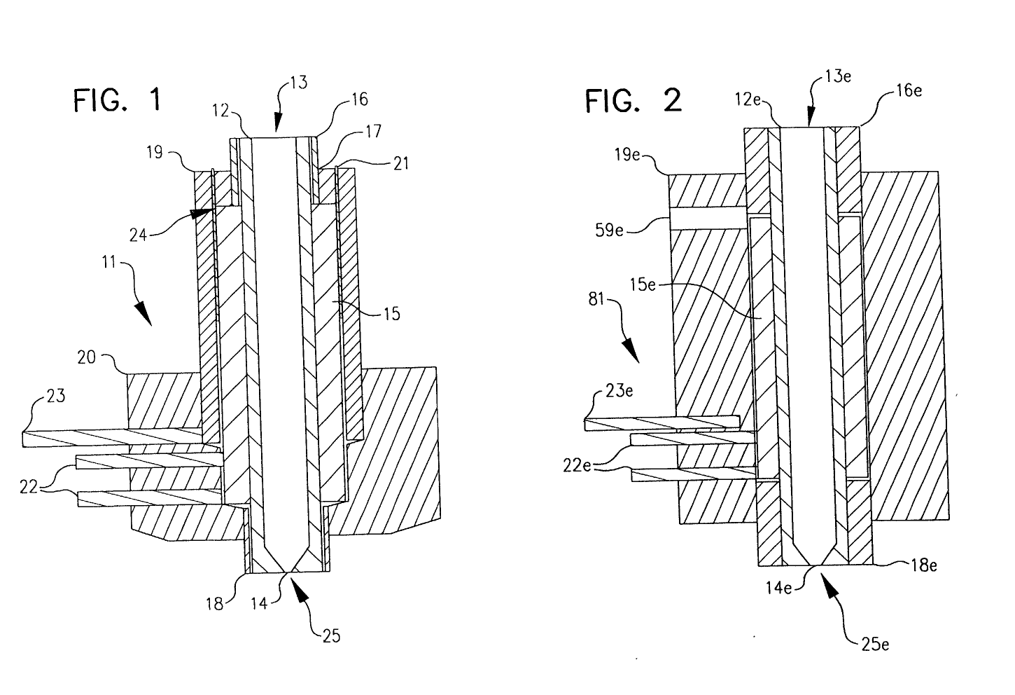

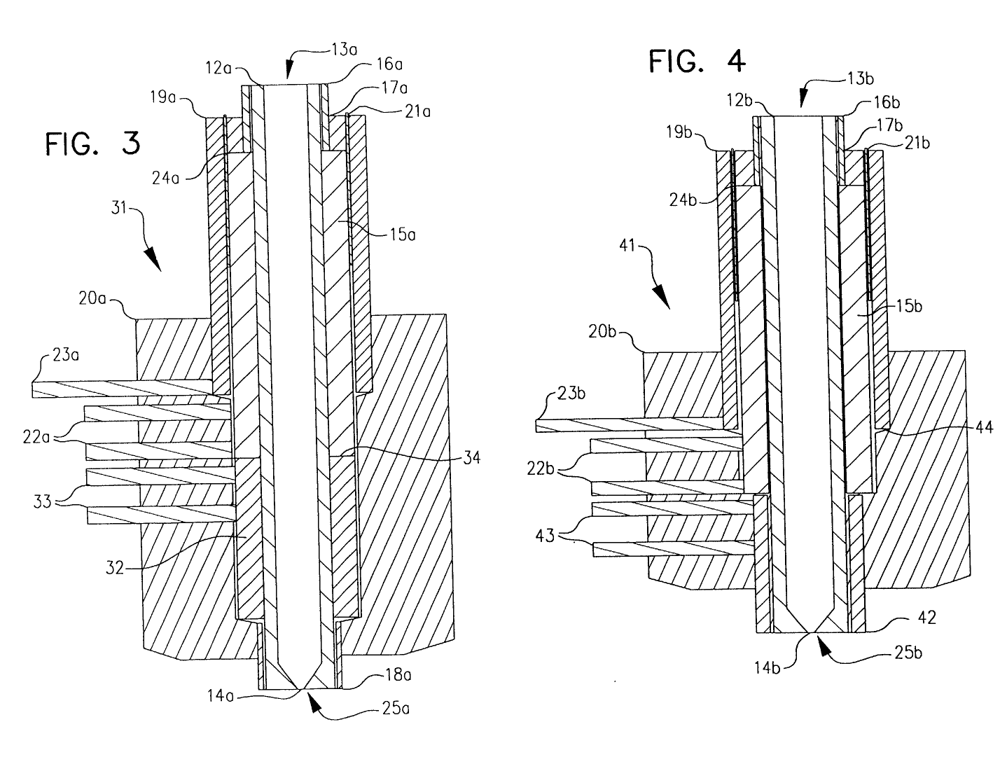

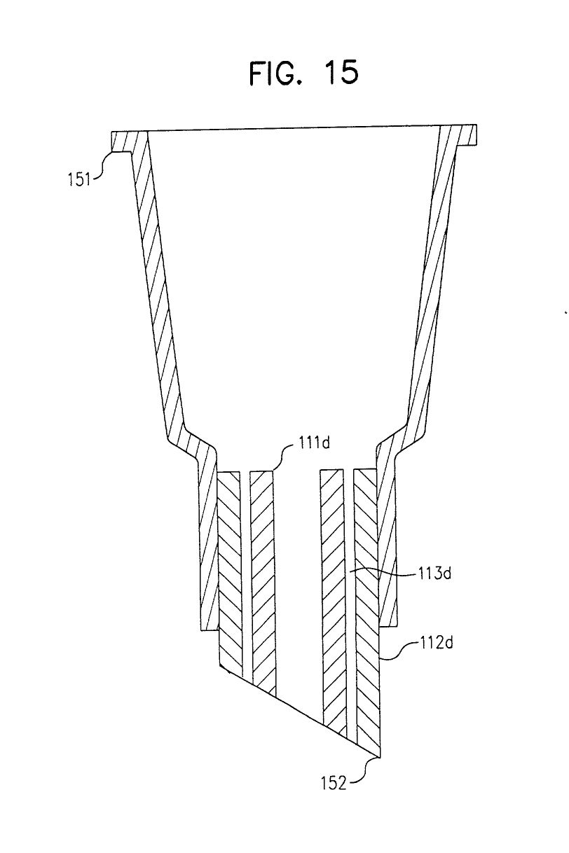

In the accompanying drawings, similar reference numerals refer to the same items in different figures. For example, reference numerals 15 in FIG. 1 and 15a in FIG. 3 both refer to the actuating piezoelectric tube. Also, for illustration purposes in the accompanying drawings, the scale in the lateral direction is three times bigger than in the longitudinal direction.

FIG. 1 is a cross-sectional view of a cylindrical piezoelectric pipetting device incorporating a protective housing. A preferred embodiment of a cylindrical piezoelectric pipetting device 11 comprises a glass or fused silica capillary tube 12 and an actuating piezoelectric tube 15 that concentrically surrounds the capillary tube 12 as disclosed in Zoltan (U.S. Pat. No. 3,840,758). The glass or fused silica capillary tube 12 has proximal and distal ends and has respective openings 13 and 25 at both ends. The proximal opening 13 is herein referred to as the ‘supply end’. The distal opening 25 at the opposite end of the capillary tube 12 is herein referred to as the ‘dispense end’. Fluid can either be acquired or dispensed through the distal opening 25, as disclosed in Wiktor (U.S. Pat. No. 6,232,129). The walls of the capillary tube 12 form a constriction or nozzle 14 at the distal opening 25. The constriction 14 is preferably formed by heating the tip of the capillary tube 12 as disclosed in Gamble (U.S. Pat. No. 5,958,342). Alternatively, the constriction is formed by simultaneously heating and pulling the glass capillary as disclosed in Hayes (U.S. Pat. No. 4,877,745). A hydrophobic coating may optionally be applied to the distal opening 25 as disclosed in Hayes. The capillary tube 12 and the piezoelectric tube 15 are enclosed in a protective housing made up of five parts: the tubes 16, 17, 18, 19 and the housing 20. The five parts composing the protective housing may be made from a wide variety of different metal or plastic materials. The tubes 18 and 19 are preferably made from ¾ to full hard type 304 or type 316 stainless steel hypodermic needle tubing, however, other rigid materials may also be used. The housing 20 is preferably manufactured from high temperature plastic, either by casting, injection molding or by machining from a solid piece of plastic using a conventional lathe and milling machine or an automatic screw machine. Some suitable plastics include polyimide, polyamide-imide or PEEK, for example. For illustration purposes in FIG. 1, the distal end of the tube 18 is shown protruding down past the housing 20 only a short distance relative to the entire length of the device. However, the distal end of the tube 18 may protrude a longer distance (such as ⅜ inch or more), making it possible to acquire fluid samples through the nozzle 14 from deep, narrow fluid containers such as the wells in high density microtiter plates, for example. At the proximal opening 13 of the device, the capillary tube 12 is protected by an end cap preferably comprised of two, ¾ to full hard type 304 or type 316 stainless steel hypodermic tubes 16 and 17. The smaller diameter tube 16 is press fit into the larger diameter tube 17, forming an end cap subassembly for the device. Alternatively, this end cap may be machined from a single piece of metal or plastic rod or tube. Alternatively, tube 16 is used by itself without tube 17. The smaller diameter tube 16 preferably protrudes out proximally past the tubes 17 and 19 as depicted in FIG. 1. In this way, the tube 16 provides a means for coupling a conventional tube (not shown) for fluid delivery to the proximal opening 13 of the device.

An actuating electrical signal is supplied to the piezoelectric tube 15 by means of electrical contacts 22. Pin 23 helps guide a conventional connector (not shown) that mates with the electrical contacts 22 and provides a means of polarizing the connector so that it can only go on one way: plus to plus and minus to minus. Mating connectors are available from Molex, Inc., Lisle, Ill., (www.molex.com), or Omnetics Connector Corporation, Minneapolis, Minn. (www.omnetics.com).

The bottom of the pin 23 pushes against the tube 19, which is electrically insulated from the piezoelectric tube 15. Washer 24 is made out of a dielectric material and provides electrical insulation between the actuating piezoelectric tube 15 and the end cap comprised of tubes 16 and 17. In some applications, the washer 24 is not necessary; the electrical insulation is provided by a gap. Heat-shrink tube 21 is also made out of a dielectric material (such as polyester) and provides electrical insulation between the piezoelectric tube 15 and the tube 19. Alternatively, an electrically insulating coating may be applied to the outside and end surfaces of the piezoelectric tube 15, providing electrical insulation between the piezoelectric tube 15 and the tubes 16, 17, 18 and 19. Alternatively, an electrically insulating conformal coating may be applied to the tubes 16, 17, 18 and 19. Preferably, this is a Parylene conformal coating applied in a vacuum to a thickness of approximately 0.0002 inch. Alternatively, high dielectric strength insulating coatings are available from GC Electronics, Rockford, Ill.

FIG. 2 is a cross-sectional view of an alternate construction of a piezoelectric pipetting device incorporating a protective housing that does not conduct electricity. The device depicted in FIG. 2 is identical to the one in FIG. 1 with the following differences: tubes 16, 17 and 19 in FIG. 1 are replaced with the single tube 16e in FIG. 2; tube 18 in FIG. 1 is replaced with the tube 18e in FIG. 2; and the housing 20 in FIG. 1 is replaced with the housing 19e in FIG. 2. Housing 19e is made out of a material such as plastic or ceramic that does not conduct electricity. The hole 59e in the wall of the housing 19e is used to supply a low viscosity adhesive via capillary action to the interior of the device during assembly as described below. Tubes 16e and 18e in FIG. 2 may be formed out of a wide variety of different plastic, metal or ceramic materials.

For applications where a voltage needs to be applied to the device or to the fluid in the device, tubes 16e and 18e are preferably made out of a non-conductive plastic or ceramic material. Typically, tubes 16e and 18e are pressed into housing 19e with a slight interference fit. Optionally, either housing 19e and tube 16e or housing 19e and tube 18e may be formed out of a single piece of plastic, metal or ceramic material. Alternatively, hybrid designs, combining the designs of the supply and dispense ends of the devices shown in FIG. 1 and FIG. 2, may be constructed. For example, the design of the distal opening 25 of FIG. 1 may be used instead of the design of the distal opening 25e of FIG. 2. Similarly, the design of the proximal opening 13 of FIG. 1 may be used instead of the design of the proximal opening 13e of FIG. 2.

FIG. 3 is cross-sectional view of a piezoelectric pipetting device incorporating a protective housing and a sensor. The cylindrical piezoelectric pipetting device 31 incorporates a sensor 32 as disclosed in Wiktor (U.S. Pat. No. 6,232,129). Device 31 in FIG. 3 is identical to the piezoelectric pipetting device 11 in FIG. 1 with the addition of the sensor 32, electrical contacts 33 and insulating washer 34. Alternatively, the constructions of FIGS. 2, 9 or 10 (described below) may be used for this device. It is advantageous to amplify the electrical signal from the sensor 32 using a preamplifier in close proximity to the electrical contacts 33 reducing the susceptibility of the electrical signal to corruption by electromagnetic interference (EMI). The sensor 32 can take other forms known to those skilled in the relevant arts in order, for example, to sense the operational state or parameters of the device 31 or any fluid contained within the device 31.

FIG. 4 is a cross-sectional view of a piezoelectric pipetting device incorporating a protective housing and a means of regulating the temperature of the tip of the device. The cylindrical piezoelectric pipetting device 41 incorporates a thermal tip 42 that enables temperature regulation of the tip of the device as disclosed in Wiktor (U.S. Pat. No. 6,232,129). Alternatively, the constructions of FIGS. 2, 9 or 10 may be used for the device 41.

A detailed cross-sectional view of the thermal tip 42 is depicted in FIG. 8. The thermal tip 42a in FIG. 8 comprises a ceramic tube 61 with platinum plating 62 and a circumferential gap 63 in the plating. Alternatively, the tube 61 may be made out of a high temperature plastic, such as polyimide, polyamide-imide or PEEK, for example. The plating material 62 wraps around both ends of the ceramic tube 61. Platinum is the preferred plating material since it has very reproducible electrical and mechanical properties and it is inert so that its electrical and mechanical properties remain constant over time. Alternatively, some other low conductivity material (such as Nichrome, for example) may be used. The electrical contacts 43f connect to the plating material 62 on either side of the circumferential gap 63, allowing an electrical current to pass in a continuous path through the plating material 62 on the interior and exterior surfaces of the tube 61. The insulating washer 44 in FIG. 4 provides electrical and thermal insulation between the thermal tip 42 and the piezoelectric tube 15b. Washer 44 may be relatively thick to provide good thermal insulation between the two elements 42 and 15b. In some embodiments, the washer 44 can be left out of the device 41. Alternatively, the housing 20b may neck down in the region between the thermal tip 42 and the piezoelectric tube 15b, providing thermal and electrical insulation between the two elements.

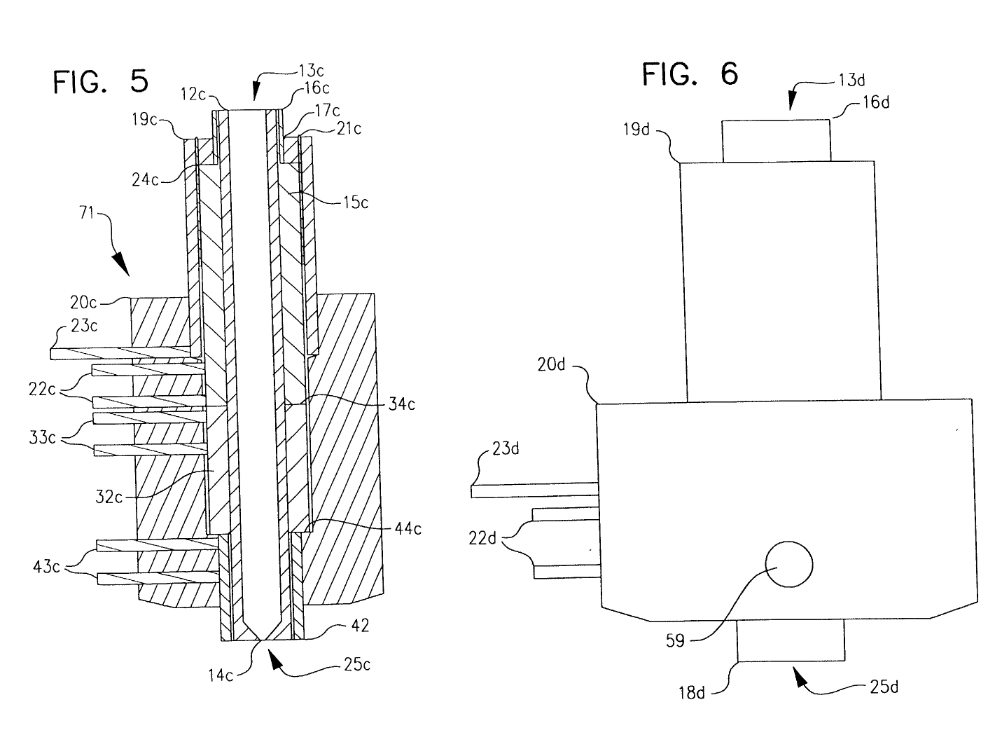

FIG. 5 is a cross-sectional view of a cylindrical piezoelectric pipetting device incorporating a protective housing, a sensor and a means of regulating the temperature of the tip of the device. The cylindrical piezoelectric pipetting device 71 incorporates both a sensing piezoelectric tube 32c and a thermal tip 42c as disclosed in U.S. Pat. No. 6,232,129. Alternatively, the construction of FIGS. 2, 9 or 10 may be used for this device. The device 71 enables all of the functionality of the devices depicted in FIG. 1, FIG. 3 and FIG. 4, namely: a means for dispensing and acquiring fluid samples through the nozzle 14c, sensing the operational state of the device by means of the sensor 32c and regulating the temperature of the tip of the device by means of the thermal tip 42c. An electrical current can also be made to pass through the inner electrodes of the actuating and/or sensing piezoelectric tubes 15c and 32c, respectively, for regulating the temperature of the fluid as disclosed in Wiktor (U.S. Pat. No. 6,232,129).

The construction of the actuating piezoelectric tube 15 in FIG. 1 and the sensing piezoelectric tube 32 in FIG. 3 (32c in FIG. 5) is identical.

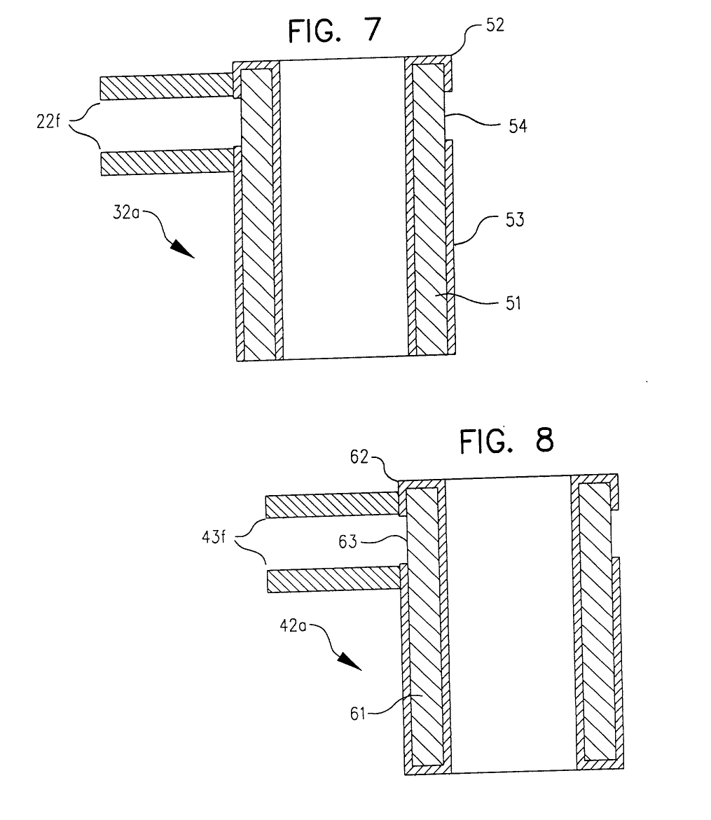

FIG. 7 is a cross-sectional view of the sensor in FIG. 3 and FIG. 5, and is a close up view of the sensing piezoelectric tube 32a. It is constructed out of a radially polarized piezoelectric ceramic tube 51. The inside and outside surfaces of the tube 51 are plated in nickel, forming the inner electrodes 52 and outer electrodes 53. The inner electrode 52 wraps around one end of the piezoelectric ceramic tube 51. There is a gap 54 between the inner 52 and outer 53 electrodes. The electrical contacts 22f (shown as electrical contacts 22 in FIG. 1 and the electrical contacts 33 in FIG. 3) make contact with the inner electrodes 52 and the outer electrodes 53 and conduct the electrical signal generated by the sensing piezoelectric tube 32. Alternatively, in the case of the actuating piezoelectric tube 15 in FIG. 1, applying a voltage across these electrical contacts 22 causes a radial voltage to be applied across the ceramic wall of the piezoelectric tube 15. This, in turn, causes the piezoelectric tube 15 to deflect radially, thus inducing an acoustic wave into the fluid of the device to dispense a drop of fluid.

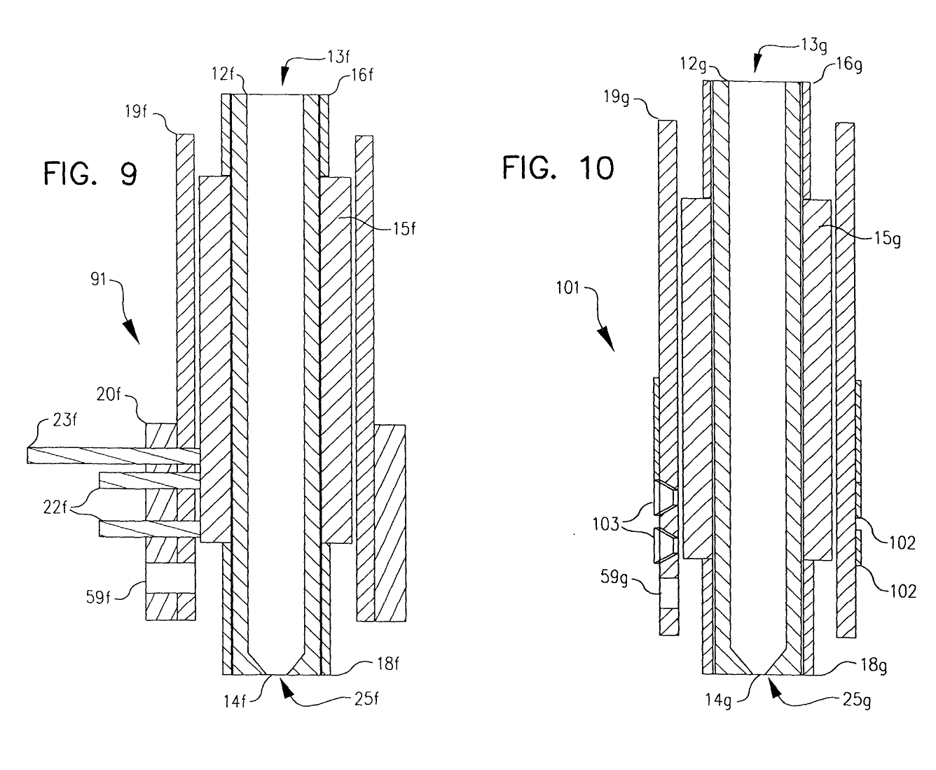

FIG. 9 is a cross-sectional view of an alternate construction of a piezoelectric pipetting device incorporating a protective housing. This device is very similar to the device in FIG. 2 except that housing 19f in FIG. 9 is made out of an electrically conducting material with a electrically non-conductive coating applied to the surface. Also there is an air gap between the inner tubes 16f and 18f and the outer tube 19f. The conformal coating is preferably made out of Parylene with a thickness of at least 0.0001″. Housing 20f in FIG. 9 is optional. It provides mechanical support for the electrical contacts 22f and guide pin 23f. Housing 20f is preferably made out of non-conductive material such as plastic.

FIG. 10 is a cross-sectional view of an alternate construction of a piezoelectric pipetting device that is very similar to the device in FIG. 9 except for the means of making electrical contact with the piezoelectric tube 15g. In FIG. 10 electrical contact is accomplished by means of two circumferential electrically conductive bands 102 applied to the surface of the tube 19g. Tube 19g is again covered with a electrically non-conductive coating, preferably Parylene. The electrically conductive bands 102 are located in precise positions along the length of the tube 19g. These positions are preferably defined using a photoresist mask. Photoresist is applied to the entire tube 19g and then allowed to dry. The tube 19g is then placed inside another close-fitting tube that functions as an optical mask.

The close-fitting tube is made out of a material that is transparent to ultraviolet light. It has two opaque bands, in the area of the conductive bands 102. Tube 19g is exposed to ultraviolet light through the optical mask. The ultraviolet light polymerizes the photoresist everywhere on the outside of the tube except for the area of the opaque bands. Tube 19g is removed from the optical mask and then dipped in a solvent to remove the unpolymerized photoresist from the two bands, exposing the Parylene underneath. The conductive bands 102 are then applied to the Paralyne either by vacuum metallization, electrolytic plating, electroless plating or electrically conductive paint. The electrically conductive coating 102 is also applied to the surface of the two counterbored holes 103. Electrical contact between the electrically conductive bands 102 and the piezoelectric tube 19g is made by applying solder or conductive epoxy through the two holes 103. Optionally, small electrically conductive pins can be inserted into the two holes 103 to facilitate electrical conductivity. Electrical contact can be made to the two bands 102, such as by soldering on wires or by means of circumferential electrical contacts. More than one of these circumferential electrical contacts can be arrayed together in a printed circuit board to hold multiple piezoelectric pipetters.

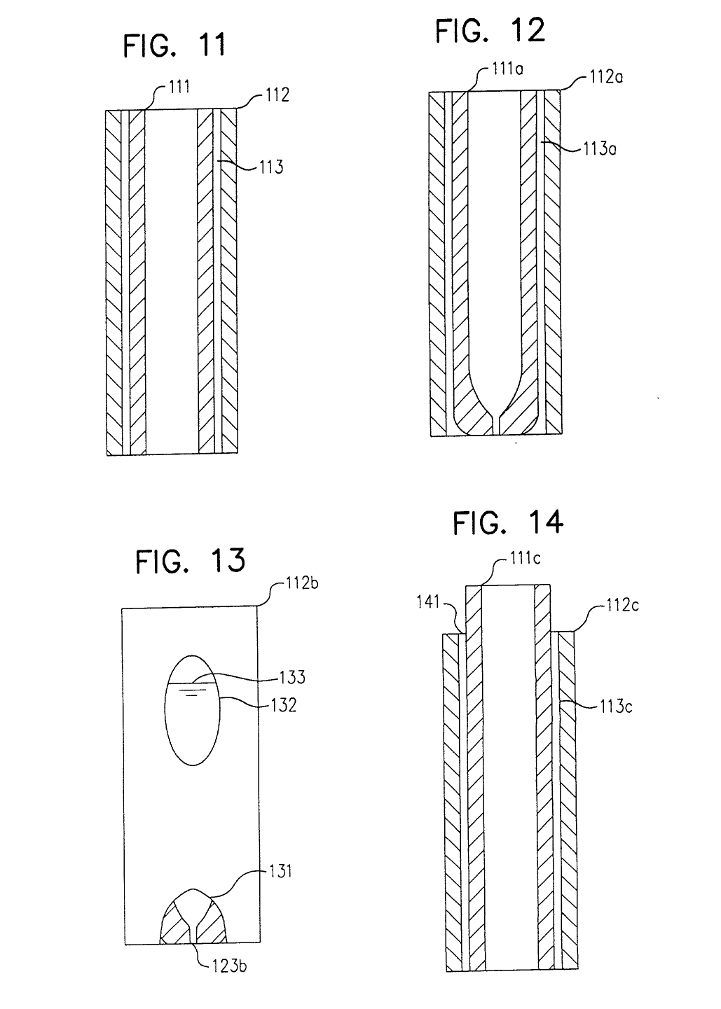

FIG. 11 is a cross-sectional view of a glass capillary tube 111 bonded inside of a rigid tube 112. Alternatively, the capillary tube 111 can be made out of fused silica. The tube 112 is preferably made out of 34 to full hard type 304 or type 316 stainless steel hypodermic needle tubing. Alternatively, the tubing may be made out of some other suitable rigid metal or plastic material.

FIG. 12 is a cross-sectional view of a glass capillary tube with a nozzle formed on one end that is bonded inside of a rigid tube. The glass capillary tube in FIG. 12 includes a bonded capillary 111a and rigid tube 112a arrangement as in FIG. 11 except with a nozzle 123 formed on one end of the capillary. Hayes (U.S. Pat. No. 4,877,745) and Gamble (U.S. Pat. No. 5,958,342) disclose how to form such a nozzle 123. The arrangement in FIG. 12 can be used, for example, for electrospray or piezoelectric drop-on-demand ink-jet print head applications as disclosed in Zoltan (U.S. Pat. No. 3,840,758).

FIG. 13 is a top view of a rigid tube with two apertures cut into its wall allowing the enclosed capillary to be observed. It shows a rigid tube 112b with two apertures 131 and 132 in the wall of the rigid tube. The nozzle 123b can be seen through aperture 131. The fluid level 133 can be seen through aperture 132. Optionally, the apertures 131 and 132 go all the way through the rigid tubing 112b.

FIG. 14 is a cross-sectional view of the same arrangement as in FIG. 11 except that the glass capillary sticks out past the rigid tube at one end.

FIG. 15 is a cross-sectional view of the protected glass capillary arrangement of FIG. 11 that is bonded to a female Luer fitting 151. The distal tips of the glass capillary tube 111d and the rigid tube 112d are optionally ground to a sharp point 152, as on a standard hypodermic needle. For illustration purposes, the tubes 111d and 112d are depicted shorter than they would actually be in a typical application. Similarly, the protected glass capillary with a nozzle formed on the end that is depicted in FIG. 12 may be bonded to a female Luer fitting 151.

The manner of assembling the device depicted in FIG. 1 is now described. The same basic assembly procedures also apply to the devices depicted in FIGS. 2, 3, 4, 5, 9, 10, 11, 12, 13, 14 and 15. All of the components composing the final device are cleaned in an ultrasonic cleaner and then dried prior to assembly. First the tube 16 is press fit inside of the tube 17, forming the end cap subassembly.

Alternatively, tube 16 is used by itself as depicted in FIG. 9 and FIG. 10.

Next, the tube 18 and then the tube 19 are inserted into the housing 20. The piezoelectric tube 15, the insulating washer 24 and the end cap subassembly are then all slipped onto a mandrel. Next, the heat-shrink insulating tube 21 is slipped over the piezoelectric element 15, the insulating washer 24 and the end cap subassembly. The insulating washer 24 is optional as depicted in FIG. 9 and FIG. 10. Heat is then applied to the heat-shrink tubing, forming the piezoelectric end cap subassembly. Then this subassembly is slipped into the stainless steel tube 19. Alternatively, a small amount of adhesive is applied to the end cap before inserting it into the stainless steel tube 19. Later on in the assembly procedure, this prevents the low viscosity adhesive from filling the gap between the piezoelectric tube 15 and the stainless steel tube 19.

Next in the assembly, a small amount of solder is soldered onto the ends of the electrical contacts 22. Then a small amount of flux is applied to the soldered ends of the electrical contacts 22 and the electrical contacts 22 and the guide pin 23 are inserted into the housing 20. The electrical contacts 22 are then soldered to the piezoelectric tube 15 by heating the exposed end of the electrical contact for a short period of time with a soldering iron. Alternatively, a conductive epoxy is used to bond the electrical contacts 22 to the piezoelectric tube 15. A low viscosity adhesive as disclosed in Hayes (U.S. Pat. No. 4,877,745) is then introduced into the opening 59 in FIG. 6. This is done by first filling a glass capillary with the low viscosity adhesive, placing one end of the glass capillary into the opening 59 and heating the assembly in an oven at approximately 85 degrees C. Within five minutes, the low viscosity adhesive is drawn into the housing by capillary action. The capillary is then removed from opening 59 and the assembly 11 is left in the oven until the adhesive cures.

The fluid volume of drops dispensed by the present invention is typically on the order of 100 picoliters per drop. The device must be completely filled with fluid in order to dispense drops. Typically, the device is coupled to a reservoir of fluid through flexible plastic tubing slipped over the tube 16 protruding out of the proximal opening 13 of the device. Hayes (U.S. Pat. No. 4,877,745) discloses the properties a fluid must have in order for it to be able to be dispensed from the nozzle 14. Applying a voltage pulse to the electrical contacts 22 causes a drop of fluid to be ejected through the nozzle 14 at the distal opening 25 of the device. Zoltan (U.S. Pat. No. 3,840,758) and Hayes (U.S. Pat. No. 4,877,745) disclose the appropriate voltage waveform shape required to eject a single drop. These two patents also disclose the physics behind the drop formation and its relationship to the waveform shape. Hayes (U.S. Pat. No. 4,877,745) also discloses the appropriate voltage waveform shape required to eject multiple drops at high frequency from the device in a resonant mode of operation.

Alternatively, fluid may be supplied through the nozzle 14 at the distal opening 25 either by applying a suction as disclosed in Pappen (U.S. Pat. No. 6,083,762) or by using the diffuser pump principle as disclosed in Wiktor (U.S. Pat. No. 6,232,129). In the latter case, fluid is acquired or drawn up into the device by submerging the nozzle 14 beneath the surface of a fluid and actuating the piezoelectric tube 15 with an alternating voltage. The physical basis for this effect is the fact that the flow resistance is smaller for fluid flowing into the device through the nozzle than for fluid flowing out of the device. Upon each expansion and subsequent contraction of the piezoelectric tube 15, fluid flows into and then out from the device through the nozzle 14. However, due to the difference in flow resistance in the two directions, there is a net flow into the device through the nozzle 14. Based on this principle, fluid samples can be acquired by repeatedly actuating the piezoelectric tube 15. For this principle to work, the capillary tube 12 must be at least partially filled with a fluid. Instead of submerging the nozzle 14 in the sample fluid, alternatively a flexible tube may be attached to both the proximal opening 13 and the distal opening 25 of the device, enabling a continuous flow fluid pump as disclosed in Wiktor (U.S. Pat. No. 6,232,129).

The manner of using the sensor 32 is disclosed in Wiktor (U.S. Pat. No. 6,232,129). The same principles apply to the sensor 32c in FIG. 5. Actuating the piezoelectric tube 15a induces an acoustic wave into the fluid contained in the capillary tube 12a. This acoustic wave is transmitted to the sensing piezoelectric tube 32 through the fluid. This causes the walls of the sensing piezoelectric tube 32 to deflect a small amount, thus inducing a voltage signal in the piezoelectric material. This voltage signal is transmitted to the electrical contacts 33 and optionally amplified before being transmitted by wires to an analog-to-digital converter. After being digitized, the signal is analyzed by means of a digital computer. Typically, this analysis involves first finding the power spectral density of the voltage signal. The digital computer has the power spectral densities of voltage signals taken under various known operating conditions stored within its memory. The current operational state of the device is determined by correlating the newly measured power spectral density with the stored power spectral densities. In this way, it can be determined if, for example, the device is clogged, empty, broken or functioning properly.

The principles of regulating the temperature of the thermal tip 42 in FIG. 4 apply also to the thermal tip 42c in FIG. 5.

FIG. 8 is a cross-sectional view of the thermal tip 42a in FIG. 4 and FIG. 5. The plating material 62 in FIG. 8 acts as both the heater and temperature sensor in this application. The resistivity of the plating material is the key property enabling both of these functions.

A current of i amps passing through the plating material with resistance R ohms causes i²R watts of power to be dissipated in the plating material in the form of heat. Ignoring temperature induced dimensional changes, the resistance R of the plating material depends on the temperature T according to the equation, R=(1+α(T−T₀))R₀, where T₀ is a nominal temperature, typically 20 degrees C., R₀ is the resistance of the material at temperature T₀ and α is the resistivity temperature coefficient of the material. For platinum, α=0.003927 C.⁻¹. The nominal resistance R₀ is determined by measuring the resistance across the plating material at the nominal temperature T₀ using an ohmmeter. The equation for R forms the basis for a temperature regulator for the thermal tip 42. The desired resistance R corresponding to a desired temperature T is calculated from the equation for R, above. The amount of current passing through the plating material is adjusted until the actual resistance as measured by an ohmmeter circuit matches the desired resistance.

The resistance R of the plating material can be determined from Ohm's law, R=v/1, by knowing the voltage drop v across the plating material and the current i passing through the plating material. The voltage drop v is regulated by a low output impedance amplifier circuit and the current i is measured using a current sense resistor or a Hall effect sensor. Alternatively, the current i is regulated in a feedback loop around a current sense resistor or a hall effect sensor and the voltage drop v is measured.

In a clinical setting, for example, the protected glass capillary can be used to acquire samples of a patient's fluid without the risk of the glass capillary breaking. A female Luer arrangement as depicted in FIG. 15 may be coupled to a syringe for applications where a standard hypodermic needle is used. The glass liner enables fluids that react with stainless steel to be aspirated or dispensed. A female Luer arrangement with a nozzle 123 can be used to dispense very narrow, precise streams of fluid through the nozzle 123. Fluid is forced through the nozzle in this application by applying pressure to the fluid by means of a syringe or some other type of pump. The pressure may be optionally regulated by means of a solenoid valve. The arrangement of the protected glass capillary tube with a nozzle formed on its end depicted in FIG. 12 has applications for electrospray and piezoelectric drop-on-demand ink-jet print heads as disclosed in Wiktor (U.S. Pat. No. 6,232,129). It can also be used to puncture the walls of a cell to inject fluid samples or to remove fluid samples. The protective rigid tube housing prevents the glass capillary from breaking in these applications.

While the foregoing is a detailed description of the preferred embodiment of the invention, there are many alternative embodiments of the invention that would occur to those skilled in the art and which are within the scope of the present invention. Accordingly, the present invention is to be determined by the following claims.

1. A protected capillary, comprising:
a glass capillary having a proximal end and a distal end, an interior surface and an exterior surface; and
a rigid tube having a proximal end and a distal end, an interior surface and an exterior surface, the exterior surface of the glass capillary being bonded to the interior surface of the rigid tube.

2. The protected capillary of claim 1, wherein the glass capillary is made from fused silica.

3. The protected capillary of claim 1, wherein the rigid tube is made from stainless steel.

4. The protected capillary of claim 3, wherein the stainless steel rigid tube is made from hypodermic needle tubing.

5. The protected capillary of claim 1, wherein the distal end of the glass capillary is formed into a nozzle.

6. The protected capillary of claim 1, wherein the rigid tube has at least one aperture formed therein.

7. The protected capillary of claim 6, wherein the rigid tube has two apertures formed therein.

8. The protected capillary of claim 5, wherein the rigid tube has at least one aperture formed therein.

9. The protected capillary of claim 8, wherein the rigid tube has two apertures formed therein.

10. The protected capillary of claim 8, wherein the nozzle is adjacent one of the two apertures.

11. The protected capillary of claim 1, wherein the proximal end of the glass capillary protrudes beyond one end of the rigid tube.

12. The protected capillary of claim 1, further comprising a female Luer fitting bonded to the distal end of the rigid tube.

13. The protected capillary of claim 1, wherein the distal ends of the glass capillary and the rigid tube are ground to a sharp point.

14. The protected capillary of claim 1, wherein the distal end of the glass capillary is formed into a nozzle and the distal end of the rigid tube is ground to a sharp point.

15. The protected capillary of claim 5, further comprising a female Luer fitting bonded to the distal end of the rigid tube.

16. A piezoelectric pipetting device, comprising:
a glass capillary having a proximal end and a distal end, an interior surface and an exterior surface, the distal end being formed into a nozzle;
a rigid tube having two ends, an interior surface and an exterior surface, a first portion of the exterior surface of the glass capillary being bonded to the interior surface of the rigid tube; and
a piezoelectric actuating element adjacent a second portion of the exterior surface of the glass capillary.

17. The piezoelectric pipetting device of claim 16, wherein the glass capillary is made from fused silica.

18. The piezoelectric pipetting device of claim 16, wherein the rigid tube is made from stainless steel.

19. The piezoelectric pipetting device of claim 18, wherein the stainless steel rigid tube is made from hypodermic needle tubing.

20. The piezoelectric pipetting device of claim 16, wherein the piezoelectric actuating element is protected by a protective housing that surrounds the piezoelectric actuating element, the protective housing being electrically non-conductive.

21. The piezoelectric pipetting device of claim 16, wherein the piezoelectric actuating element is protected by an electrically conductive protective housing having surfaces, the surfaces being coated with an electrically non-conductive layer.

22. The piezoelectric pipetting device of claim 16, wherein the piezoelectric actuating element has circumferential electrical contacts and is protected by an electrically conductive protective housing having surfaces, the surfaces being coated with an electrically non-conductive layer.

23. The piezoelectric pipetting device of claim 16, further comprising:
an electrical connector adapted to be removably connected to the circumferential electrical contacts of the piezoelectric actuating element.

24. A piezoelectric pipetting device, comprising:
a glass capillary having a proximal end and a distal end, an interior surface and an exterior surface, the distal end being formed into a nozzle;
a rigid tube having two ends, an interior surface and an exterior surface, a first portion of the exterior surface of the glass capillary being bonded to the interior surface of the rigid tube;
a piezoelectric actuating element adjacent a second portion of the exterior surface of the glass capillary; and
a sensor adjacent a third portion of the exterior surface of the glass capillary.

25. The piezoelectric pipetting device of claim 24, wherein the glass capillary is made from fused silica.

26. The piezoelectric pipetting device of claim 24, wherein the rigid tube is made from stainless steel.

27. The piezoelectric pipetting device of claim 26, wherein the stainless steel rigid tube is made from hypodermic needle tubing.

28. The piezoelectric pipetting device of claim 24, wherein the piezoelectric actuating element is protected by a protective housing that surrounds the piezoelectric actuating element.

29. A piezoelectric pipetting device, comprising:
a glass capillary having a proximal end and a distal end, an interior surface and an exterior surface, the distal end being formed into a nozzle;
a rigid tube having two ends, an interior surface and an exterior surface, a first portion of the exterior surface of the glass capillary being bonded to the interior surface of the rigid tube;
a piezoelectric actuating element adjacent a second portion of the exterior surface of the glass capillary; and
a temperature regulator adjacent the exterior surface of an end of the glass capillary.

30. The piezoelectric pipetting device of claim 29, wherein the glass capillary is made from fused silica.

31. The piezoelectric pipetting device of claim 29, wherein the rigid tube is made from stainless steel.

32. The piezoelectric pipetting device of claim 31, wherein the stainless steel rigid tube is made from hypodermic needle tubing.

33. The piezoelectric pipetting device of claim 29, wherein the piezoelectric actuating element is protected by a protective housing that surrounds the piezoelectric actuating element.

34. A piezoelectric pipetting device, comprising:
a glass capillary having a proximal end and a distal end, an interior surface and an exterior surface, the distal end being formed into a nozzle;
a rigid tube having two ends, an interior surface and an exterior surface, a first portion of the exterior surface of the glass capillary being bonded to the interior surface of the rigid tube;
a piezoelectric actuating element adjacent a second portion of the exterior surface of the glass capillary;
a sensor adjacent a third portion of the exterior surface of the glass capillary; and
a temperature regulator adjacent the exterior surface of an end of the glass capillary.

35. The piezoelectric pipetting device of claim 34, wherein the glass capillary is made from fused silica.

36. The piezoelectric pipetting device of claim 34, wherein the rigid tube is made from stainless steel.

37. The piezoelectric pipetting device of claim 36, wherein the stainless steel rigid tube is made from hypodermic needle tubing.

38. The piezoelectric pipetting device of claim 34, wherein the piezoelectric actuating element is protected by a protective housing that surrounds the piezoelectric actuating element.

39. A method for making a protected capillary, comprising the steps of:
a) forming a glass capillary having a proximal end and a distal end, an interior surface and an exterior surface;
b) forming a rigid tube having a proximal end and a distal end, an interior surface and an exterior surface; and
c) bonding the exterior surface of the glass capillary to the interior surface of the rigid tube.

40. The method of claim 39, further comprising the step of:
d) forming the distal end of the glass capillary into a nozzle.

41. The method of claim 40, further comprising the step of:
e) forming a protective housing that surrounds the piezoelectric actuating element, the protective housing being electrically non-conductive.

42. The method of claim 40, further comprising the step of:
e) forming an electrically conductive protective housing that surrounds the piezoelectric actuating element, the electrically conductive protective housing having surfaces, the surfaces being coated with a electrically non-conductive layer.

43. The method of claim 42, further comprising the step of:
f) forming circumferential electrical contacts on the piezoelectric actuating element.

44. The method of claim 43, further comprising the step of:
g) removably connecting an electrical connector to the circumferential electrical contacts of the piezoelectric actuating element.

45. The method of claim 39, further comprising the step of:
d) forming at least one aperture in the rigid tube.

46. The method of claim 39, further comprising the step of:
d) bonding a female Luer fitting to the distal end of the rigid tube.

47. The method of claim 39, further comprising the step of:
d) shaping the distal ends of the glass capillary and the rigid tube to a sharp point.

48. A method for making a protected capillary, comprising the steps of:
a) forming a glass capillary having a proximal end and a distal end, an interior surface and an exterior surface;
b) forming the distal end of the glass capillary into a nozzle;
c) forming a rigid tube having two ends, an interior surface and an exterior surface;
d) bonding a first portion of the exterior surface of the glass capillary to the interior surface of the rigid tube;
e) forming a piezoelectric actuating element; and
f) affixing the piezoelectric actuating element adjacent a second portion of the exterior surface of the glass capillary.

49. The method of claim 48, further comprising the step of:
g) forming a protective housing that surrounds the piezoelectric actuating element, the protective housing being electrically non-conductive.

50. A method for making a piezoelectric pipetting device, comprising the steps of:
a) forming a glass capillary having a proximal end and a distal end, an interior surface and an exterior surface;
b) forming the distal end into a nozzle;
c) forming a rigid tube having two ends, an interior surface and an exterior surface;
d) bonding a first portion of the exterior surface of the glass capillary to the interior surface of the rigid tube;
e) forming a piezoelectric actuating element;
f) affixing the piezoelectric actuating element adjacent a second portion of the exterior surface of the glass capillary;
g) forming a sensor; and
h) affixing the sensor adjacent a third portion of the exterior surface of the glass capillary.

51. The method of claim 50, further comprising the step of:
i) forming a protective housing that surrounds the piezoelectric actuating element.

52. A method for making a piezoelectric pipetting device, comprising the steps of:
a) forming a glass capillary having a proximal end and a distal end, an interior surface and an exterior surface;
b) forming the distal end of the glass capillary into a nozzle;
c) forming a rigid tube having two ends, an interior surface and an exterior surface;
d) bonding a first portion of the exterior surface of the glass capillary to the interior surface of the rigid tube;
e) forming a piezoelectric actuating element;
f) affixing the piezoelectric actuating element adjacent a second portion of the exterior surface of the glass capillary;
g) forming a temperature regulator;
h) affixing the temperature regulator adjacent the exterior surface of an end of the glass capillary.

53. The method of claim 52, further comprising the step of:
i) forming a protective housing that surrounds the piezoelectric actuating element.

54. A method for using a piezoelectric pipetting device, comprising the steps of:
a) actuating a piezoelectric actuating element, adjacent a first portion of an exterior surface of a glass capillary having a proximal end and a distal end, to draw a fluid into the glass capillary, a second distinct portion of the exterior surface of the glass capillary being bonded to an interior surface of a rigid tube;
b) accessing a sensor adjacent a third portion of the exterior surface of the glass capillary to determine an operational state of the fluid; and
c) determining an action based on the operational state of the fluid.
